(19) United States
(12) Patent Application Publication
(10) Pub. No.: US 2026/0106385 A1
(43) Pub. Date: Apr. 16, 2026

(54) Busbar Fastener

(71) Applicant: Illinois Tool Works Inc., Glenview, IL (US)

(72) Inventors: Richard Ellis, Sant Cugat del Valles (ES); Victoria Plana García, Barcelona (ES)

(21) Appl. No.: 19/353,273

(22) Filed: Oct. 8, 2025

(30) Foreign Application Priority Data
Oct. 11, 2024 (EP) 24206223.0
Sep. 11, 2025 (DE) 102025136749.3

(51) Int. Cl. H01R 4/30; H01R 4/34

(52) U.S. Cl. CPC H01R 4/305; H01R 4/34

(57) ABSTRACT

A busbar fastener (102, 302) is described. The busbar fastener is suitable for connecting to at least one busbar (104). The busbar fastener includes opposing arms (110) that are arranged to capture a busbar therebetween. At least one fixation (108) is arranged to cooperate with a complementary fixation (108) such that together the fixations urge at least one busbar towards the busbar fastener. A kit of parts is also disclosed.

### RELATED APPLICATIONS

The present application claims the benefit of European Patent Application No. 24206223.0, filed Oct. 11, 2024, and German Patent Application No. 10 2025 136 749.3, filed Sep. 11, 2025, each titled “Busbar Fastener,” the contents of which are hereby incorporated by reference.

### BACKGROUND

The disclosure relates to a busbar fastener suitable for connecting to at least one busbar. Busbars are used to connect circuit devices together, such as battery cells in electric vehicles. It can be difficult to achieve a reliable electronic connection between busbars particularly in vehicles which may be subject to wide temperature variations between seasons and/or vibrations from use of the vehicle. Such environmental conditions can cause disruption to the electrical connection. Busbars can also be time consuming to install and difficult to connect to other parts of the vehicles.

### SUMMARY

The present disclosure relates generally to a busbar fastener, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates an exploded view of a busbar fastener.

FIG. 1b illustrates an installed busbar fastener.

FIG. 2 illustrates a cross section through an installed busbar fastener.

FIG. 3a illustrates a first view of an alternative busbar fastener.

FIG. 3b illustrates a cross section through the alternative busbar fastener.

FIG. 3c illustrates a further view of the alternative busbar fastener.

FIG. 4a illustrates an exploded view of the alternative busbar fastener.

FIG. 4b illustrates an installed alternative busbar fastener.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “coupled,” “coupled to,” and “coupled with” as used herein, each mean a relationship between or among two or more devices, apparatuses, elements, functions, operations, processes, components, systems, subsystems, and/or means, constituting any one or more of: (i) a connection, whether direct or through one or more other devices, apparatuses, files, elements, functions, operations, processes, components, systems, subsystems, or means; and/or (ii) a functional relationship in which the operation of any one or more devices, apparatuses, elements, functions, operations, processes, components, systems, subsystems, or means depends, in whole or in part, on the operation of any one or more others thereof.

According to the disclosure there is provided a busbar fastener suitable for connecting to at least one busbar, the busbar fastener comprising: opposing arms arranged to capture a busbar therebetween; at least one fixation arranged cooperate with a complementary fixation such that together the fixations urge at least one busbar towards the busbar fastener. In this way the busbar may be securely grasped by the opposing arms and held in place by the cooperating fixations.

The busbar fastener may be formed by stamping. Manufacture of the busbar fastener may be in a single step and therefore simplified. The busbar fastener may be formed from a single piece of material thereby minimizing complexity of structure and guaranteeing electrical conductivity throughout the busbar fastener.

The at least one fixation may take the form of, or have a shape describing, a well. A shape of the at least one fixation may alternatively describe a peg. The complementary fixation may take the opposite form to allow the two fixations to cooperate e.g., By insertion of the peg into the well. The at least one fixation may be arranged to be located within an aperture of the at least one busbar in order to fasten to the busbar.

The opposing arms may be arranged to capture at least two busbars therebetween and thereby hold two busbars in electrical connection with one another. This may be achieved by extending the arms such their length is sufficient to grasp both busbars.

The busbar fastener may further comprise at least one clip arranged to connect the busbar fastener to a further component.

The busbar fastener may further comprise at least one electrical conduction coupler in order to further improve and assure electrical conductivity between busbars. The at least one electrical conduction coupler may be arranged about the at least one fixation.

The at least one electrical conduction coupler may be arranged to ensure electrical conductivity between multiple busbars, e.g., By interference or a biting fit.

The at least one electrical conduction coupler may comprise one or more teeth arranged to bite into one or more busbars and thereby provide a biting fit.

The at least one electrical conduction coupler comprises copper and/or aluminum to ensure good electrical connection.

In a further part of the disclosure there is provided a kit of parts suitable for connecting to at least one busbar comprising: a busbar fastener which comprises: opposing arms arranged to capture a busbar therebetween; and at least one fixation a complementary fixation arranged to cooperate with the at least one fixation such that together the fixations urge at least one busbar towards the busbar fastener; an optional electrical conduction coupler; and an optional resilient member arranged to locate between the a busbar and the complementary fixation, and optionally wherein the resilient member absorbs slack movement and further optionally wherein the resilient member is a spring.

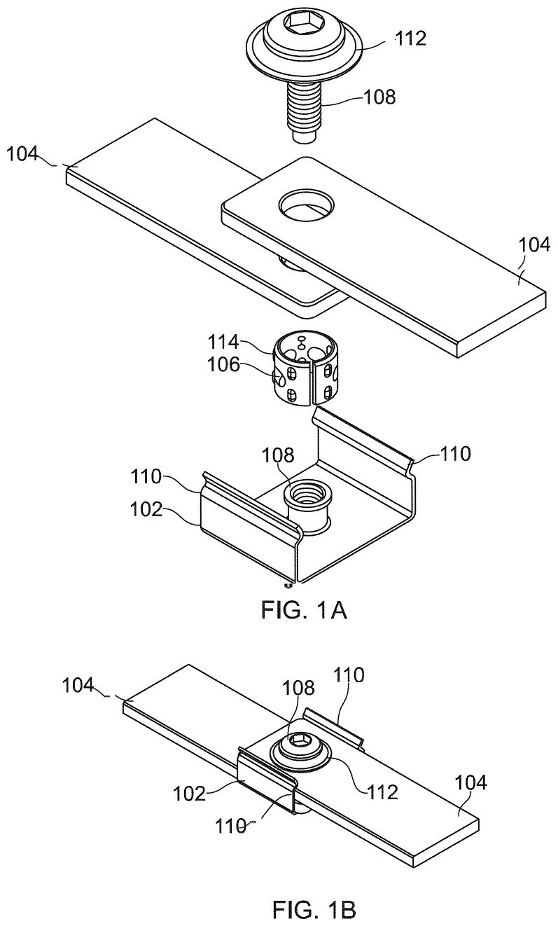

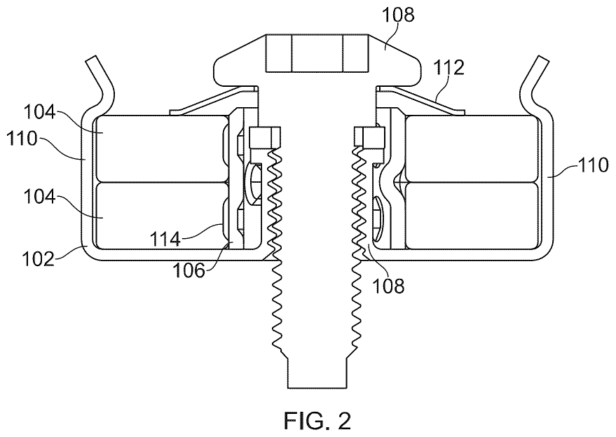

The busbar fastener 102 shown in FIG. 1 and FIG. 2 is intended to keep busbars in position and apply a clamping force to make and maintain an electrical connection across the busbars. The busbar fastener 102 is suitable for connecting to at least one busbar 104 or multiple busbars. Typically, the busbar fastener will be used to connect two busbars together and maintain an electrical connection across the busbars. The busbar fastener 102 comprises opposing arms 110 which are arranged to capture a busbar therebetween. These may be formed of a resilient material, such as steel. The opposing arms may be arranged to capture at least two busbars or any required number of busbars therebetween.

At least one fixation 108 is provided on the busbar fastener 102 and arranged to cooperate with a complementary fixation 108 such that together the fixations urge at least one busbar towards the busbar fastener and thereby provide a secure connection and hold of the busbars by the busbar fastener 102. Any suitable pair of fixations may be used, hence the common reference number, and can include a well and peg, threaded bar and aperture, rivet, snap fit system, or the like.

The at least one fixation provided on the busbar fastener 102 may be a well or similar tunnel (blind or otherwise). The shape of the at least one fixation may describe a peg, in other words, standing proud of a surface of the busbar fastener 102 in order to locate with a feature of the busbar e.g., the at least fixation is arranged to locate within an aperture of the at least one busbar.

Where the fixation 108 describes a peg, the fixation 108 provides compression limiting of the busbar fastener. This limits how much the busbars may be urged towards the busbar fastener 102 thereby protecting relatively softs materials of e.g., The electrical conduction coupler 106 (typically formed of Al/Cu alloys) from being crushed through over-tightening. Having at least one fixation formed as a peg therefore prevents overtightening as the peg or other feature, will abut against the other fastener.

The busbar fastener can be formed by stamping thereby simplifying manufacture. The busbar fastener may be formed from a single piece of material further simplifying manufacture.

The opposing arms 110 may possess hands which are chamfered or angled in order to ease the mounting operation of the busbars into the busbar fastener 102. The hands may therefore guide the busbar into the embrace of the arms.

The busbar fastener can (but not essentially) further comprise at least one electrical conduction coupler 106. The electrical conduction coupler is arranged about the at least one fixation (e.g., when taking the shape of a peg as described above). The electrical conduction coupler can be arranged to ensure electrical conductivity between multiple busbars is maintained/is present.

The at least one electrical conduction coupler comprises copper and/or aluminum to provide electrical conductivity. The electrical conduction coupler can comprise one or more teeth 114 arranged to bite into one or more busbars to ensure good electrical contact. The electrical conduction coupler 106 ensures electrical connection through the busbars. The electrical conduction coupler 106 may take the form of a studded bushing for example.

The busbar fastener may be provided as a kit of parts suitable for connecting to at least one busbar. The kit can comprise a busbar fastener as any described in this application. A complementary fixation is provided to cooperate with the at least one fixation of the busbar fastener such that together the fixations urge at least one busbar towards the busbar fastener. An optional electrical conduction coupler and an optional resilient member 112 may also be provided with the kit. Optionally the resilient member may absorb slack movement between the parts, as such the e resilient member may be spring, sprung washer, elastomer or the like.

The resilient member 112 compensates for Z-axis movement, such as thermal expansion/contraction and/or mechanical fatigue.

The busbar fastener 102 may be provided preassembled with the electrical conduction coupler 106 and the complementary fixation 108 provided with the resilient member 112 ready for installation.

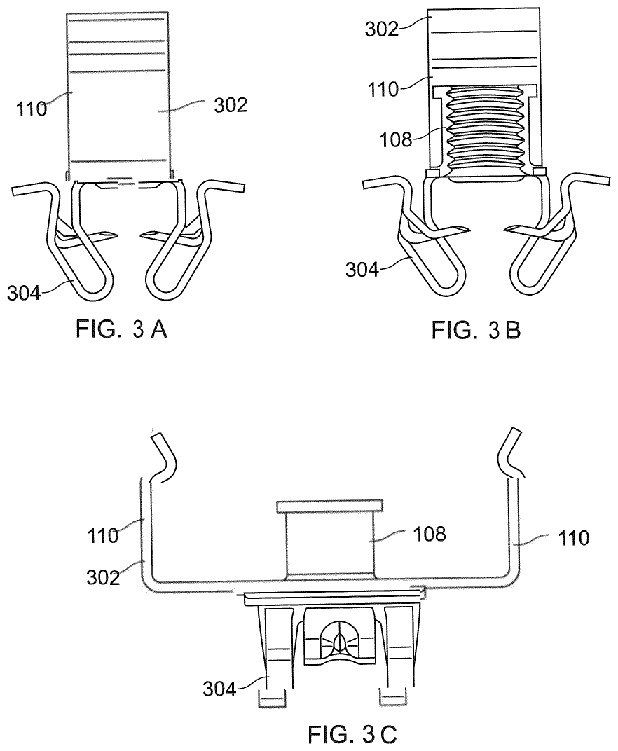

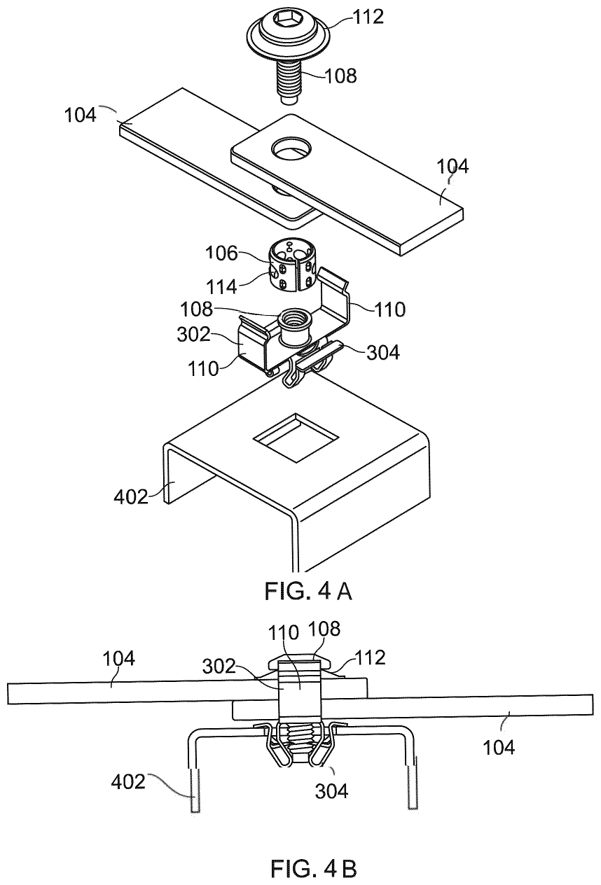

The busbar fastener 302 shown in FIG. 3 and FIG. 4 is similar to that shown in FIG. 1 and FIG. 2. Like features are provided with the same reference numerals and not further discussed so as to avoid unnecessary repetition. The busbar fastener 302 further comprises at least one clip 304 arranged to connect the busbar fastener to a further component 402. The clip 304 allows attachment of the busbar fastener 302 to a further component 402, such as a battery module, etc. The clip 304 may be formed integrally with the busbar fastener 302 and the same manufacturing process or the clip 304 may be manufactured separately and fitted to the busbar fastener 302 later.

The clip 304 is shown as a resilient form that can be intentionally disconnected, but any other attachment means may be used as appropriate and such means may be permanent or reversible as required by the situation.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract or drawings), or to any novel one, or any novel combination, of the steps of any method or process disclosed.

What is claimed is:

1. A busbar fastener (102, 302) suitable for connecting to at least one busbar (104), the busbar fastener comprising:
opposing arms (110) arranged to capture a busbar therebetween; and
at least one fixation (108) arranged cooperate with a complementary fixation (108) such that together the fixations urge at least one busbar towards the busbar fastener.

2. The busbar fastener of claim 1, wherein the busbar fastener is formed by stamping and/or wherein the busbar fastener is formed from a single piece of material.

3. The busbar fastener of claim 1, wherein the at least one fixation is a well and/or wherein a shape of the at least one fixation describes a peg and/or the at least fixation arranged to locate within an aperture of the at least one busbar.

4. The busbar fastener of claim 1, wherein the opposing arms are arranged to capture at least two busbars therebetween.

5. The busbar fastener of claim 1, wherein the busbar fastener further comprises at least one clip (304) arranged to connect the busbar fastener to a further component (402).

6. The busbar fastener of claim 1, wherein the busbar fastener further comprises at least one electrical conduction coupler (106) and optionally wherein the at least one electrical conduction coupler is arranged about the at least one fixation.

7. The busbar fastener of claim 6, wherein the at least one electrical conduction coupler is arranged to ensure electrical conductivity between multiple busbars.

8. The busbar fastener of claim 6, wherein the at least one electrical conduction coupler comprises one or more teeth (114) arranged to bite into one or more busbars.

9. The busbar fastener of claim 6, wherein the at least one electrical conduction coupler comprises copper and/or aluminum.

10. A kit of parts suitable for connecting to at least one busbar comprising:
a busbar fastener which comprises:
opposing arms arranged to capture a busbar therebetween; and
at least one fixation
a complementary fixation arranged to cooperate with the at least one fixation such that together the fixations urge at least one busbar towards the busbar fastener;
an optional electrical conduction coupler; and
an optional resilient member (112) arranged to locate between the busbar and the complementary fixation, and optionally wherein the resilient member absorbs slack movement and further optionally wherein the resilient member is a spring.
